(19) United States
(12) Patent Application Publication
(10) Pub. No.: US 2015/0070892 A1
(43) Pub. Date: Mar. 12, 2015

(54) LIGHTING SYSTEM AND A LIGHTING DEVICE AND BASE MEMBER

(71) Applicant: Koninklijke Philips N.V., Eindhoven (NL)

(72) Inventor: Carsten Florian WITSCH, Aachen (DE)

(21) Appl. No.: 14/542,886

(22) Filed: Nov. 17, 2014

Related U.S. Application Data
(63) Continuation of application No. 13/320,975, filed on Mar. 28, 2012.

(30) Foreign Application Priority Data
May 19, 2009 (EP) 09160567.5

(51) Int. Cl. F21V 21/096; F21K 99/00; F21V 21/008; F21S 8/00; F21S 6/00; F21V 21/30; F21V 23/00

(52) U.S. Cl. CPC F21V 21/096; F21V 21/30; F21K 9/30; F21V 23/003; F21S 8/033; F21S 6/002; F21V 21/008; F21Y 2101/02
USPC 362/249.03; 362/398

(57) ABSTRACT

The invention relates to a lighting system comprising at least one base member and at least one lighting device, the lighting device being able to be brought into functional connection with at least one supporting structure by means of the base member, and the base member comprising at least one first connecting member and the lighting device comprising at least one second connecting member that is able to be brought into function connection with the first connecting member, an attractive magnetic force also being able to be generated between the first connecting member and the second connecting member, and to a lighting device and a base member.

### TECHNICAL FIELD OF THE INVENTION

The invention relates to a lighting system comprising at least one base member and at least one lighting device, the lighting device being able to be brought into functional connection with at least one supporting structure by means of the base member, and the base member comprising at least one first connecting member and the lighting device comprising at least one second connecting member that is able to be brought into functional connection with the first connecting member, and to a base member that can be used in the said lighting system and to a lighting device that can be used in the said lighting system.

### BACKGROUND OF THE INVENTION

Known from the prior art are lighting systems in which a base member is fastened to a supporting structure such as a wall or ceiling of a room, and a lighting device can be placed in functional connection with the base member by means of an appropriate connecting member both mechanically and to allow it to be supplied with energy. In this way, U.S. Pat. No. 6,939,179 B1 for example discloses a modular plug-in electrical wiring system. It is proposed that a first universal electrical module be arranged on a supporting structure such as a ceiling of a room by means of a screwed connection. The first modular unit has electrical connecting members and a second modular unit, which is part of a lighting device and in particular of a lamp, can be inserted in the first universal electrical modular unit in such a way that when it is inserted in the first modular unit an electrical connection is made. To allow the second modular unit to be fastened to the first modular unit, provision is made for the two units to be connected together by means of screws.

However, this system has the disadvantage that it is only in a complicated way, if at all, that the lighting system can be adapted by a user to a desired lighting situation, and in particular, if there is to be a change in the relative positions of the two universal units, the screwed connections have to be undone to enable a different relative position to be set between the universal units.

It is therefore an object of the present invention to further develop the lighting system of the generic kind in such a way that the disadvantages of the prior art are overcome and in particular a lighting system is provided which, due to its being of modular construction, makes it possible for the lighting system to be adapted easily to a desired lighting situation.

### SUMMARY OF THE INVENTION

This technical object is achieved by virtue of the fact that an attractive magnetic force is able to be generated between the first connecting member and the second connecting member.

Provision may in particular be made in this case for the first connecting member and the second connecting member to be able to be brought into functional connection, to enable a mechanical, and in particular a frictional and/or positively interengaged, connection and/or an electrical connection to be made between the base member and the lighting device.

A particular preference in the above embodiment is for the base member to comprise a first energy source and/or for the first base member to be able to be electrically connected to at least one second energy source, the base member preferably comprising at least one third connecting member and the second energy source, and/or at least one electrical lead member preferably comprising at least one fourth connecting member, an attractive magnetic force being able to be generated in particular between the third connecting member and the fourth connecting member, and/or the first energy source and/or the second energy source comprising at least one non-rechargeable battery, at least one storage battery and/or a connection to an electrical supply network.

What the invention also proposes is that the first connecting member, the second connecting member, the third connecting member and/or the fourth connecting member comprise at least one magnet, which latter comprises in particular at least one permanent magnet and/or at least one electromagnetic means, the attractive magnetic force being able to be generated between the first connecting member and the second connecting member, and/or between the third connecting member and the fourth connecting member, by means of the magnet, with, in particular, the first connecting member comprising at least one first magnet, the second connecting member comprising at least one second magnet, the third connecting member comprising at least one third magnet and/or the fourth connecting member comprising at least one fourth magnet.

It is also preferred in this case for the first connecting member to comprise, at least in a region or regions, at least one first material able to be attracted by a magnetic field generated by the second magnet, for the second connecting member to comprise, at least in a region or regions, at least one second material able to be attracted by a magnetic field generated by the first magnet, for the third connecting member to comprise, at least in a region or regions, at least one third material able to be attracted by a magnetic field generated by the fourth magnet, for the fourth connecting member to comprise, at least in a region or regions, at least one fourth material able to be attracted by a magnetic field generated by the third magnet and/or for the first connecting member to comprise the first magnet and the second connecting member to comprise the second magnet and/or for the third connecting member to comprise the third magnet and the fourth connecting member to comprise the fourth magnet.

The invention further proposes that the first connecting member and/or the third connecting member, on the one hand, comprise or comprises at least one first contact member and that the second connecting member and/or the fourth connecting member, on the other hand, comprise or comprises at least one second contact member that is able to be brought into electrical connection with the first contact member, the first contact member and the second contact member preferably being so designed, and in particular being so arranged on a surface of the first connecting member, the second connecting member, the third connecting member and/or the fourth connecting member, that an electrical connection can be made between the first connecting member on the one hand and the second connecting member on the other hand and/or between the third connecting member on the one hand and the fourth connecting member on the other hand in at least two, and preferably a plurality of, relative positions between the first connecting member on the one hand and the second connecting member on the other hand and/or between the third connecting member on the one hand and the fourth connecting member on the other hand.

It is also preferred for the first connecting member and/or the third connecting member to comprise at least one first contact surface and for the second connecting member and/or the fourth connecting member to comprise a second contact surface complementary to the first contact surface, the attractive magnetic force being able to be generated in particular between the first contact surface and the second contact surface, and/or the first contact surface having in at least one first point of symmetry, at least one first axis of symmetry and/or at least one first plane of symmetry and/or the second contact surface having at least one second point of symmetry, at least one second axis of symmetry and/or at least one second plane of symmetry.

The above lighting system may also be characterized in that the first contact member, and in particular at least one, and preferably a plurality of, first contact means that the first contact member comprises, is/are of a form that is symmetrical, and in particular rotationally symmetrical, mirror-image symmetrical and/or point symmetrical, about the first point of symmetry, the first axis of symmetry and/or the first plane of symmetry, and/or in that the second contact member, and in particular at least one, and preferably a plurality of, second contact means that the second contact member comprises, is/are of a form that is symmetrical, and in particular rotationally symmetrical, mirror-image symmetrical and/or point symmetrical, about the second point of symmetry, the second axis of symmetry and/or the second plane of symmetry, and/or in that the first plane of symmetry and the second plane of symmetry, the first axis of symmetry and the second axis of symmetry and/or the first point of symmetry and the second point of symmetry coincide at least when the first connecting member is connected to second connecting member by means of the attractive magnetic force.

It is also preferred for the base member to comprise a plurality of first connecting members that are arranged in particular on different surfaces of the base member, and in particular for the base member to comprise a first surface adjacent the supporting structure and for at least two second surfaces different from the first surface to comprise at least one first connecting member, with the first surface and the second surfaces preferably being formed by surfaces of a regular polyhedron, cuboid, cube, pyramid and/or rhombus that is formed in particular by the base member.

It is also proposed in accordance with the invention that the supporting structure comprises at least one wall of a room, at least one ceiling of a room and/or at least one piece of furniture such as a table and/or a chair, and/or that the base member comprises at least one wall mounting, at least one lamp foot, at least one free-swinging means and/or at least one supporting member able to be connected to at least one cable system.

It is also preferred for the lighting device to comprise at least one light-emitting member, the light-emitting member preferably being connected to, and/or being able to be moved relative to, the second connecting member by means of at least one first joint means, and/or for the lighting device to comprise at least two, and in particular a plurality of, light-emitting members that are connected together or are able to be moved relative to one another by means of at least one second joint means, the first joint means and/or the second joint means being in particular self-locking and/or steplessly movable, and comprising at least one sliding joint, at least one rotating joint, at least one screwed joint, at least one sliding and rotating joint, at least one universal joint and/or at least one hinge, and/or the light-emitting member comprising at least one light-emitting diode (LED) and/or at least one organic light-emitting diode (OLED).

A lighting system according to the invention may also be characterized by at least one control and/or regulating means that the light-emitting member, the first connecting member, the second connecting member and/or the base member comprise or comprises, with at least one operating parameter, and in particular an emission spectrum, at least one brightness of emission and/or at least one period of illumination and/or operation, of the lighting device being able to be controlled and/or regulated by means of the control and/or regulating means, and the lighting device preferably being able to be switched on, switched off and/or dimmed by means thereof.

Finally, it is proposed for the lighting system according to the invention that the third connecting member comprises at least one power strip and the fourth connecting member comprises at least one plug member able to be plugged onto the power strip and/or that the third connecting member comprises at least one female receptacle for at least one male connecting member that the fourth connecting member comprises, and/or that the fourth connecting member comprises at least one female receptacle for at least one male connecting member that the third connecting member comprises.

As well as this, the invention also provides a base member that can be used in a lighting system according to the invention.

Also, the invention provides a lighting device that can be used in a lighting system according to the invention.

The invention is thus based on the surprising finding that, by the provision of a magnetic connection between a connecting member that a first base member comprises and a second connecting member that a lighting device comprises, the lighting system can be easily adjusted by a user to suit a desired lighting situation. In this way, the user can easily detach the lighting device from the base member by overcoming the magnetic force and can then easily connect the lighting device again with an altered relative position between the lighting device and the base member. As well as a frictional and/or positively engaged connection, the connecting of the first connecting member and the second connecting member preferably also makes an electrical connection between the base member and the lighting device to ensure that there is a supply of energy to the lighting device. In this way, the base member may for example take the form of a strip, able to be fastened to a wall, on which at least one lighting device, and preferably a plurality of lighting devices, can be positioned. The lighting devices may in this case be arranged on, i.e. connected to, the strip at any desired distance from one another and in any desired position relative to the strip. No additional tools are required for fastening the lighting device to the base member in this way, because an attractive force acts between the base member and the lighting device as soon as the lighting device is arranged at a predetermined distance from the base member.

However, a magnetic attractive force is not confined to the connection between the lighting device and the base member and provision may also be made for the base member to comprise a third connecting member that can be brought into functional interaction with a fourth connecting member, and in particular a plug on an electrical lead, by means of a magnetic force. Particularly when the lighting system takes the form of a table lamp, this connection prevents the table lamp from being able to fall over if for example there is a jerk on the electrical lead relative to the base member. In this way, the connection between the third connecting member and the fourth connecting member is automatically released if there is a pull in the form of a jerk on the connecting lead, and any transmission of force to the rest of the table lamp is thus avoided and the table lamp is thus able to stand safety and securely on a supporting surface.

What is more, the third connecting member may also take the form of an electrical guide strip on which the fourth connecting member, which may for example take the form of a plug, is freely displaceable, in order in particular to enable the plug to be positioned as satisfactorily as possible on the base member in this way, particularly to allow for the electrical connecting lead connected to the plug if it is of only limited length.

The lighting device comprises in particular a light-emitting member in the form of an organic light-emitting diode (OLED) that in particular is connected to the first connecting member by means of a self-locking first joint means. The form taken by the first joint means makes it possible for the light-emitting member to be aligned at any angle relative to the supporting structure and for it to remain steady in this position as a result of the self-locking properties of the first joint means.

The lighting device is thus based on a lighting element which is divided into two main sections, i.e., preferably into the light-emitting member and the first connecting member that acts as a supply and controlling member. The first connecting member preferably has a first contact member that has for example a first contact means in the form of a centrally arranged plug by which it is ensured that there is an electrical supply to the light-emitting member.

By means of a control and/or regulating means that is arranged in particular in the first connecting member, the light-emitting member is able to be steplessly dimmed, and in particular the color of the light from it can be changed.

Provision may also be made in this case for the control and/or regulating means to have a press-button that is arranged on an upper face of a base member and that has a light gap that does or does not emit light depending on the switched state of the switch.

In particular embodiments, provision may be made for the base member to have an energy source of its own or for energy to be able to be fed to the base member by means of an external electrical supply. Provision may in particular be made in this case for the base member to be able to be connected to a cable system, in which case the cable system is not confined to the use of an electrically conductive cable but may also comprise comparatively stiff electrically conductive bar members or rod members.

Provision may also be made for the lighting device to comprise at least two light-emitting members that are connected together by means of a second joint means. This enables the solid angles that are illuminated by the individual light-emitting members to be selected in such a way that a desired lighting situation is obtained.

Further features and advantages of the invention can be seen from the following description, in which preferred embodiments of the invention are explained in detail by reference to the drawings.

### BRIEF DESCRIPTION OF THE DRAWINGS

In the drawings:

FIGS. 1a-1c are perspective views of a first embodiment of lighting device that can be used in a lighting system according to the invention.

FIGS. 2a, 2b are perspective views of first and second embodiments of base member that can be used in a lighting system according to the invention.

FIG. 3 is a perspective view of a first embodiment of lighting system according to the invention that comprises the lighting device shown in FIGS. 1a to 1c and the base member shown in FIG. 2a.

FIG. 4 is an exploded perspective view of the base member shown in FIG. 2a.

FIGS. 5a-5c are perspective views of a second embodiment of lighting system according to the invention that comprises the lighting device shown in FIGS. 1a to 1c and the base member shown in FIG. 2b, showing the lighting system in various operating positions.

FIG. 6 is a perspective view of a third embodiment of base member that can be used in a lighting system according to the invention.

FIGS. 7a, 7b are perspective views of a third embodiment of lighting system according to the invention that comprises the lighting device shown in FIGS. 1a to 1c and the base member shown in FIG. 6, in two different configurations.

FIG. 8 is a perspective view of a fourth embodiment of lighting system according to the invention that comprises two lighting devices and a fourth embodiment of base member.

FIG. 9 is a perspective view of a detail of the lighting system shown in FIG. 8.

FIG. 10 is a perspective view of a fifth embodiment of lighting system according to the invention that comprises a second embodiment of lighting device and a fifth embodiment of base member.

FIG. 11 is a perspective view of a detail of the lighting system shown in FIG. 10.

FIG. 12 is a perspective view of a detail of the lighting system shown in FIG. 10.

FIG. 13 is a perspective view of a sixth embodiment of lighting system according to the invention that comprises the lighting device shown in FIGS. 1a to 1c and a sixth embodiment of base member.

FIG. 14 is a perspective view of a detail of the lighting system shown in FIG. 13.

### DETAILED DESCRIPTION OF THE EMBODIMENTS

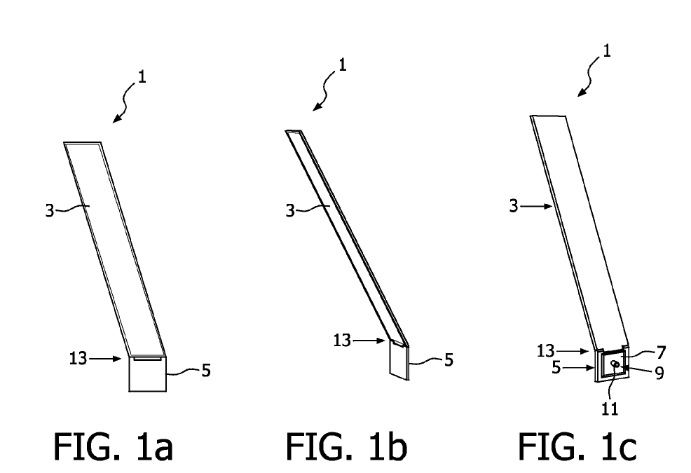

FIGS. 1a to 1c are perspective views of a first embodiment of lighting device 1 that can be used in a lighting system according to the invention. FIGS. 1a and 1b are views of the front of the lighting device 1, whereas FIG. 1c is a view of the rear of the lighting device 1. The lighting device 1 comprises a light-emitting member in the form of an organic light-emitting member or an organic light-emitting diode (OLED) member 3. By means of a base member that will be explained at a later point, the lighting device 1 can also be combined to form a lighting system. For this purpose, the base member has a first connecting member and the lighting device 1 has a second connecting member 5. By means of the second connecting member 5, on the one hand a mechanical connection is made between the lighting device 1 and the base member, and on the other hand an electrical connection is made to supply the light-emitting diode member 3 with energy. For this purpose the base member, various embodiments of which will be described below, has a first contact surface and at least one first contact member, to which the second connecting member 5 comprises a complementary second contact surface 7 and a complementary second contact member 9. As will be explained below, a first contact member may have one or more first contact means for making an electrical connection to second contact means of the second contact member. The second contact member 9 comprises for example a second contact means in the form of a contact pin 11.

The light-emitting diode member 3 is connected to the second connecting member 5, in such a way as to be movable relative thereto, by means of a first joint means in the form of a self-locking hinge 13.

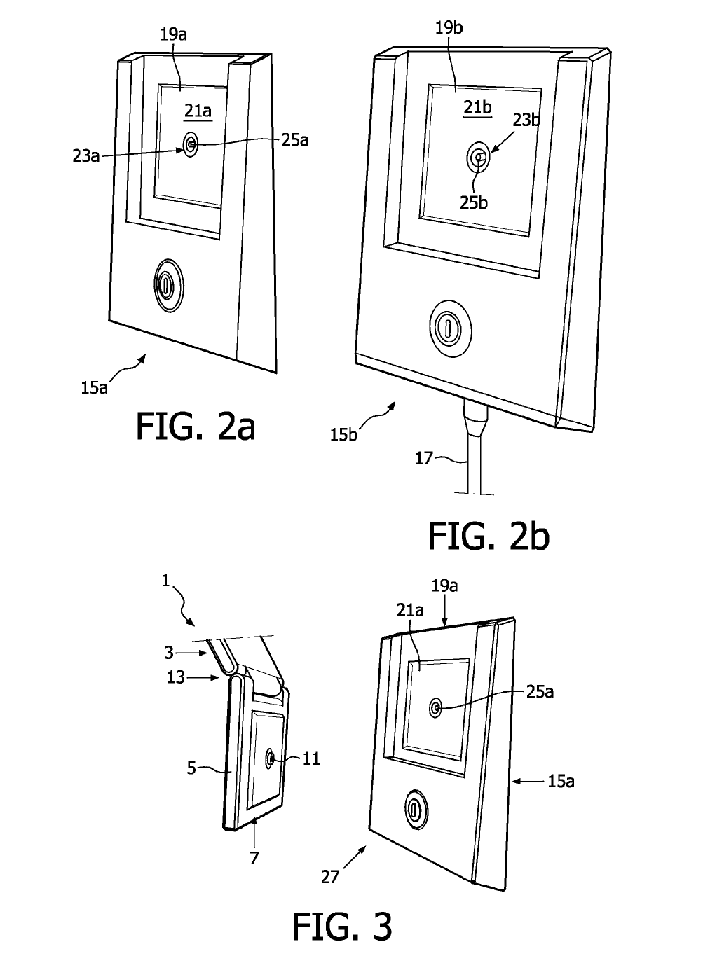

Shown in FIGS. 2a and 2b are perspective views of a first embodiment of base member 15a (FIG. 2a) and a second embodiment of base member 15b (FIG. 2b) both of which can be used in a lighting system according to the invention. The base member 15a differs from the base member 15b in that the base member 15a comprises a first energy source (not shown), comprising in particular a non-rechargeable battery and/or a storage battery, whereas the base member 15b is connected to a second energy source in the form of an electrical supply network, and can be supplied with electrical energy, by means of an electrical lead member in the form of a lead 17.

The base members 15a and 15b have respective first connecting members 19a, 19b having first contact surfaces 21a, 21b and first contact members 23a, 23b auf. The contact members 23a, 23b have in this case receptacles 25a, 25b for the contact pin 11 of the lighting device 1.

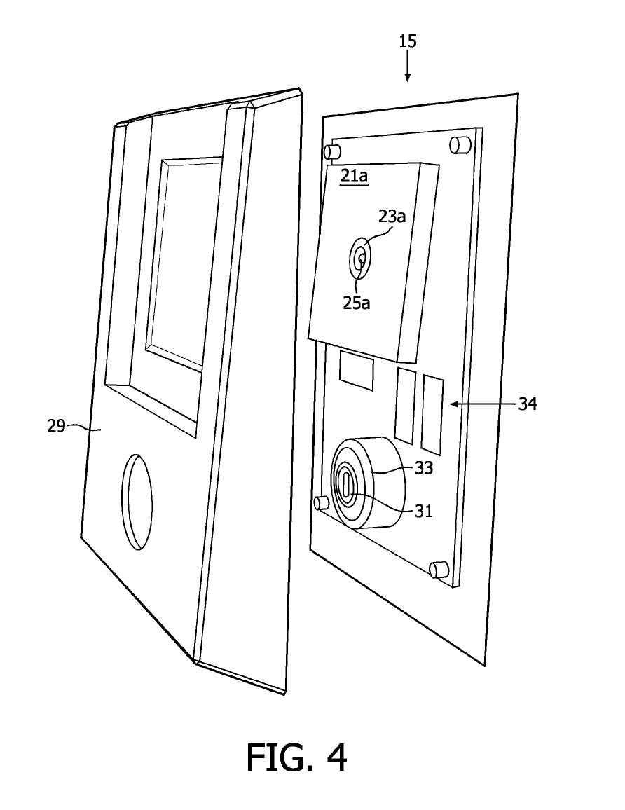

Shown in FIG. 3 is a perspective view of a first embodiment of lighting system 27 according to the invention. The lighting system 27 comprises in particular the base member 15a and the lighting device 1. In accordance with the invention, an attractive magnetic force is produced between the first connecting member 19a and the second connecting member 5 when the first connecting member 19a is brought together with the second connecting member 5. For this purpose, the first connecting member 19a comprises a permanent magnet in the region of the contact surface 21a and the second connecting member 5 comprises a material that is attracted by the magnetic field generated by the permanent magnet. A mechanical connection between the base member 15a and the lighting device 1 is secured in this way. The connection can be released by a user of the lighting system without the need for an additional tool and all that he needs to do is to exert a tractive force on the lighting device 1 to overcome the magnetic force of attraction between the lighting device 1 and the base member 15a.

As can also be seen from FIG. 3, the first contact surface 21a and the second contact surface 7 have complementary outline shapes and profilings and, due to their being of square outline shapes, are constructed to be of mirror-image symmetry about their respective centers of area. The first contact member 23a, or to be more exact the receptacle 25a, and the second contact member 9, or to be more exact the contact pin 11, are arranged to be symmetrical about their said respective centers of area. This arrangement of the contact members 9, 23a makes it possible for the lighting device 1, i.e. the second connecting member 5, to be rotated about the center of area to any desired angle relative to the first connecting member 19a, i.e. the base member 15a, in the plane of the contact surface 7, in which case it can be relied upon that there will an electrical connection between the contact pin 11 and the receptacle 25a in any position. However, because of the outline shape of the contact surfaces 21a and 7, a mechanical connection can only guaranteed at each of rotational increments of approximately 90°.

Shown in FIG. 4 is a perspective exploded view of the base member 15a. The base member 15a comprises an enclosing cover 29. As is also shown, the base member 15a also comprises a switch 31 for switching the lighting device 1 on and off. The switch 31 is surrounded by a light gap 33 that emits light particularly when the lighting device 1 is switched off, to enable the switch 31 to be located. The switch 31 is arranged on a printed-circuit board that has suitable circuit components to enable it to form a control and/or regulating means 34. This control and/or regulating means 34 makes it possible for various operating parameters of the lighting device 1 to be set, and in particular for it to be dimmed, for example by the switch 31 being pressed for a fairly long period, and/or for the emission spectrum of the light-emitting diode member 3 to be changed.

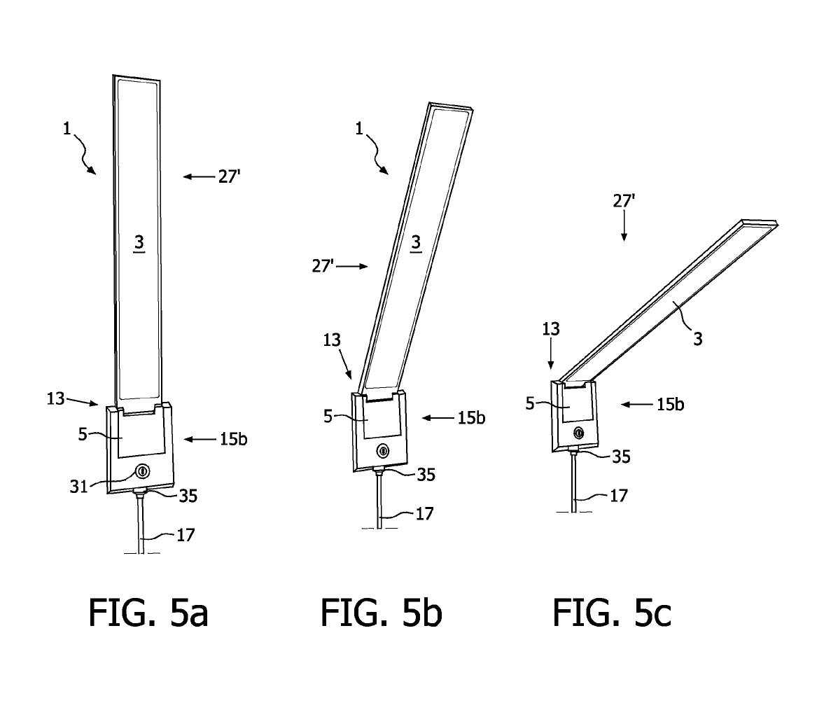

Shown in FIGS. 5a to 5c is a second embodiment of lighting system 27′. This lighting system 27′ differs from the lighting system 27 merely in that rather than the base member 15a it is the base member 15b that has been connected to the lighting device 1. As can be seen from FIGS. 5a to 5c, the base member 15b constitutes a wall mounting and is connected to a supporting structure in the form of a wall of a room, thus causing the lighting system 27′ to form a wall lamp. Because of the self-locking hinge 13, the light-emitting diode member 3 can be aligned at various angles to the connecting member 5 and hence to the wall of the room. In this way, it is a direction perpendicular to the wall of the room that can, in essence, be illuminated in the position shown in FIG. 5a, whereas in the position shown in FIG. 5c a direction that is downward relative to the wall is illuminated and the lighting system 27′ is for example used as a reading lamp. The lighting device 1 can also be changed to configurations that are not shown by releasing the lighting device 1 from the base member by overcoming the attractive magnetic force between the first connecting member 19b and the second connecting member 5 by pulling it away, and by rotating it on an axis of rotation that extends perpendicularly to the wall of the room, or rather to the contact surface 21b, through in particular 90°, 180° or 270° and then connecting it to the base member 15b again by means of the attractive magnetic force between the first connecting member 19b and the second connecting member 5. This makes it possible for lighting to the left, to the right or upwards also to be obtained in FIGS. 5a to 5c.

The base member 15b also has a third connecting member, in the form of a (female) receptacle, for a fourth connecting member in the form of a (male) plug 35 on the lead 17. An attractive magnetic force is also produced between the third connecting member, i.e. the receptacle, and the fourth connecting member, i.e. the plug, to secure the plug 35 in the receptacle. There is no provision for any further mechanical connection in the form of, for example, a clamped, clipped or latching connection. This ensures that, in the event of a force in the form of a jerk being exerted on the lead 17, the connection between the lead 17 and the base member 15b will be released without an excessively high force that might result in the base member 15b being detached from the wall of the room being exerted on the base member 15b.

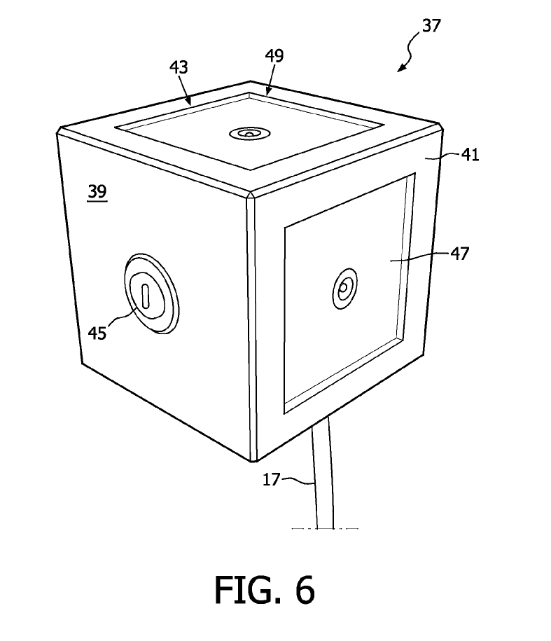

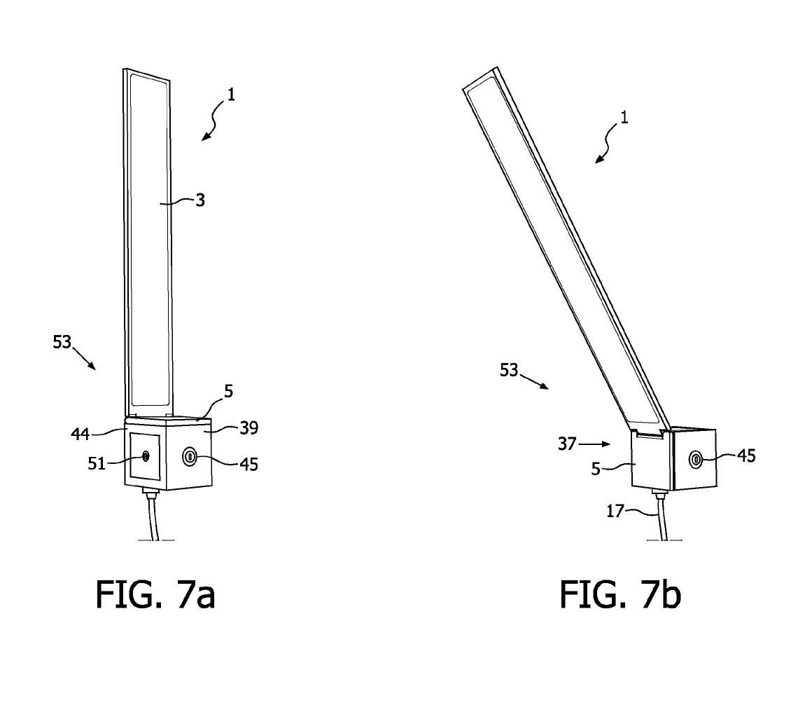

Shown in FIG. 6 is a third embodiment of base member 37 that can likewise be used as a wall mounting. The base member 37 differs from base member 15b in essence only in that it is of substantially cubic geometry. Various components of the base member 37 are arranged on respective ones of the side-faces 39, 41, 43, 44 (see also FIG. 7a). A switch 45 is arranged on the side-face 39, whereas first connecting members 47, 49, 51 (see also FIG. 7a) are arranged on, respectively, the side-faces 41, 43 of the cube and the opposite side-face 44 thereof from the side-face 43 (see also FIG. 7a). The first connecting members 47, 49, 51 are similar in design to the first connecting member 19b. The design described for the base member 37 enables the lighting device 1 to be arranged on the appropriate one of the side-faces 41, 43, 44 by connecting the second connecting member 5 to the respective connecting member 47, 49, 51, and allows a desired direction of illumination to be set for the lighting device 1 in this way.

Shown in FIGS. 7a and 7b is a third embodiment of lighting system 53 according to the invention. The lighting system 53 comprises in particular the base member 37 and the lighting device 1. Shown in FIG. 7a is a configuration of the lighting system 53 in which the lighting device 1 is connected to the connecting member 49 on the side-face 43, whereas what is shown in FIG. 7b is a configuration of the lighting system 53 in which the lighting device 1 is connected to the connecting member 51 on the side-face 44.

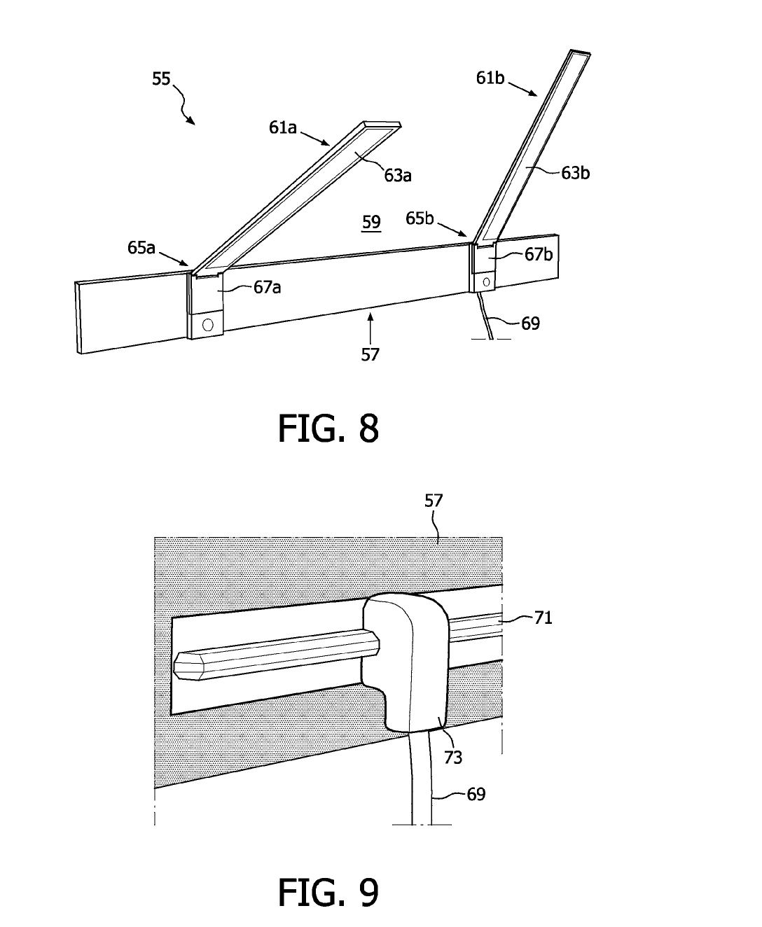

Shown in FIG. 8 is a perspective view of a fourth embodiment of lighting system 55 according to the invention. The lighting system 55 comprises a strip 57 that forms a base member and that is mounted on a supporting structure in the form of a wall 59 of a room. The lighting system 55 also comprises two lighting devices 61a, 61b. The lighting devices 61a, 61b have respective OLED members 63a, 63b that are connected to second connecting members 67a, 67b by hinges 65a, 65b. The surface of the strip 57 forms the first connecting member of the lighting system 55 and comprises a magnetic material. This latter causes an attractive magnetic force to be exerted on the connecting members 67a, 67b and causes the latter to be connected to the strip 57 in this way. In contrast to the previous embodiments however there is no electrical contact between the first connecting member and the second connecting member and instead electrical energy is transmitted from the strip 57 to the lighting devices 61a, 61b inductively in the case of the lighting system 55. Energy is supplied to the strip 57 by means of a lead 69.

Shown in FIG. 9 is a perspective view of a detail of the rear of the strip 57. As can be seen from FIG. 9, the strip 57 comprises a power strip 71 that constitutes a third connecting member. A fourth connecting member in the form of a plug 73 on the lead 69 can be connected to the power strip. This connection is made by means of an attractive magnetic force between the plug 73 and the power strip 71, in which case, in particular, the plug 73 comprises a permanent magnet and the power strip 71 comprises a material that is attracted by the magnetic field produced by the permanent magnet.

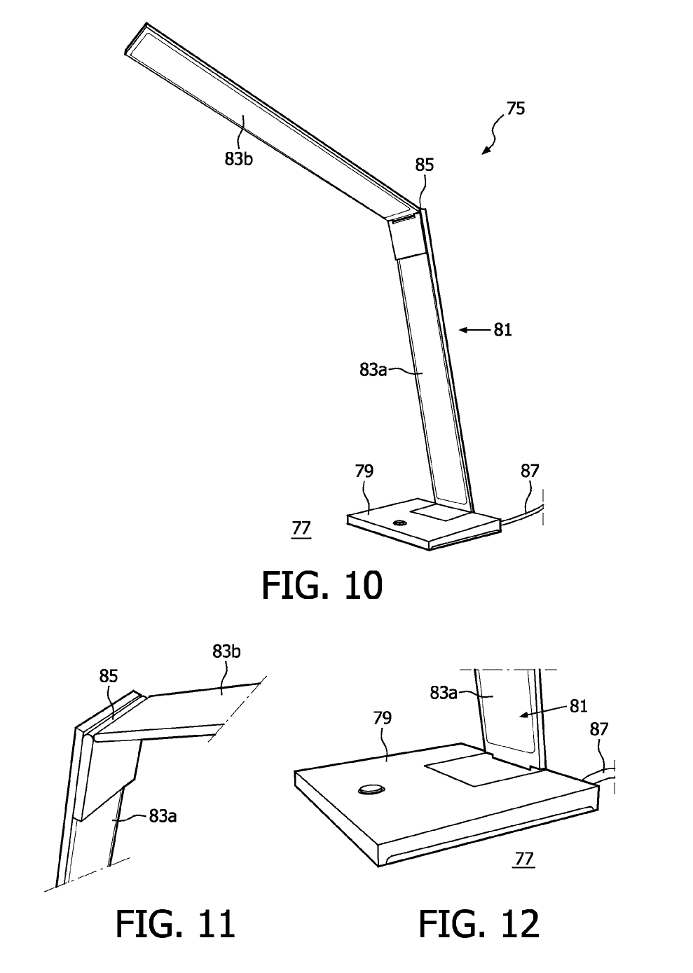

Shown in FIG. 10 is a fifth embodiment of lighting system according to the invention in the form of a table lamp 75. Perspective views of details of the table lamp 75 are shown in FIGS. 11 and 12. The table lamp 75 is arranged on a supporting structure in the form of the surface 77 of a table and comprises a first base member in the form of a lamp foot 79. A lighting device 81 is connected to the lamp foot 79 by means of corresponding connecting members that substantially correspond to the connecting members 5 and 19a or 19b. Unlike the lighting device 1, the lighting device 81 however has two OLED members 83a, 83b. These latter are, as can be seen from FIG. 11, connected together in such a way as to be movable relative to one another via a second joint means in the form of a hinge 85. By aligning the OLED members 83a, 83b relative to one another it is possible to set whatever angle of illumination is desired for the OLED member 83b in the given case relative to the surface 77 of the table. In a similar way to the OLED member 3, the OLED member 83a may, as desired, be connected by a hinge to a second connecting member for fastening to the lamp foot 79, or may be rigidly connected to the second connecting member. Energy is supplied to the table lamp 75 via a lead 87, this lead 87 being able to be connected to the lamp foot 79 in a similar way to the lead 17, i.e. by means of magnetic interaction. This ensures that, in the event of there being a high tractive force on the lead 87, the connection to the lamp foot 79 will be released and in this way the table lamp 75 will be prevented from shifting on the surface 77 of the table or from falling off it.

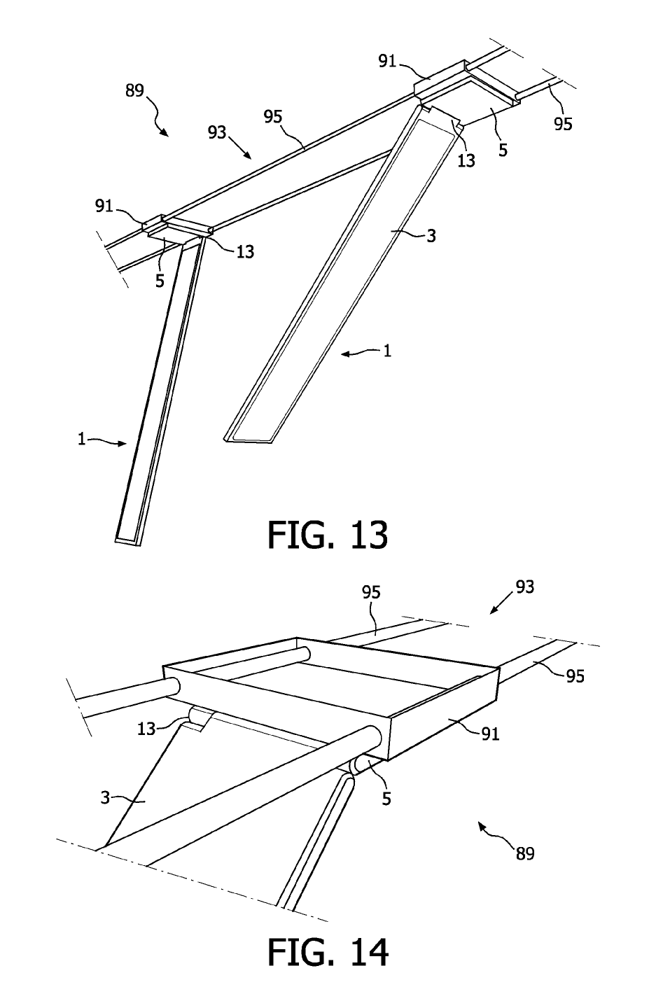

Finally, FIGS. 13 and 14 show a sixth embodiment of lighting system 89 according to the invention. The lighting system 89 comprises a plurality of first lighting devices 1 and respective base members 91. The base members 91 are connected to a supporting structure in the form of a cable system 93. The cable system 93 comprises supporting members 95 that take the form of wire cables or ropes. Provision may also be made for the supporting members to take the form of rods. The base members 91 have connecting members (not shown) that are of similar design to the connecting members 19a and 19b and a magnetic connection can in particular be made between the base members 91 and the second connecting members 5 of the lighting devices 1. The respective lighting device 1 can also be arranged in different positions relative to the base members 91, as can be seen by comparing the relative positions of the base members 91 and the lighting devices 1, i.e. the connecting members 5, in FIG. 13.

The features that are disclosed in the foregoing description, in the claims and in the drawings may be material to the invention in its different embodiments both individually and in any desired combination.

### LIST OF REFERENCE NUMERALS

1 Lighting device
3 Light-emitting diode member
5 Connecting member
7 Contact surface
9 Contact member
11 Contact pin
13 Hinge
15a, 15b Base member
17 Lead
19a, 19b Connecting member
21a, 21b Contact surface
23a, 23b Contact member
25a, 25b Receptacle
27, 27′ Lighting system
29 Enclosing cover
31 Switch
33 Light gap
34 Control and/or regulating means
35 Plug
37 Base member
39 Side-face
41 Side-face
43 Side-face
44 Side-face
45 Switch
47 Connecting member
49 Connecting member
51 Connecting member
53 Lighting system
55 Lighting system
57 Strip
59 Wall of a room
61a, 61b Lighting device
63a, 63b OLED member
65a, 65b Hinge
67a, 67b Connecting member
69 Lead
71 Power strip
73 Plug
75 Table lamp
77 Surface of table
79 Lamp foot
81 Lighting device
83a, 83b OLED member
85 Hinge
87 Lead
89 Lighting system
91 Base member
93 Cable system
95 Supporting member

1. A lighting system comprising at least one base member and at least one lighting device, the lighting device being able to be brought into functional connection with at least one supporting structure by means of the base member and the base member comprising at least one first connecting member and the lighting device comprising at least one second connecting member that is able to be brought into functional connection with the first connecting member, and an attractive magnetic force is able to be generated between the first connecting member and the second connecting member characterized in that the lighting device comprises at least one light-emitting member, the light-emitting member being connected to, and/or being able to be moved relative to, the second connecting member by means of at least one first joint means, and/or the lighting device comprises at least two, and in particular a plurality of, light-emitting members that are connected together or are able to be moved relative to one another by means of at least one second joint means, the first joint means and/or the second joint means being in particular self-locking and/or steplessly movable, and comprising at least one sliding joint, at least one rotating joint, at least one screwed joint, at least one sliding and rotating joint, at least one universal joint and/or at least one hinge, and/or the light-emitting member comprising at least one light-emitting diode (LED) and/or at least one organic light-emitting diode (OLED).

2. A lighting system as claimed in claim 1, characterized in that the first connecting member and the second connecting member can be brought into functional connection to enable a mechanical, and in particular a frictional and/or positively interengaged, connection and/or an electrical connection to be made between the base member and the lighting device.

3. A lighting system as claimed in claim 2, characterized in that the base member comprises a first energy source and/or the first base member is able to be electrically connected to at least one second energy source, the base member preferably comprising at least one third connecting member and the second energy source and/or at least one electrical lead member comprising at least one fourth connecting member, an attractive magnetic force being able to be generated in particular between the third connecting member and the fourth connecting member and/or the first energy source and/or the second energy source comprising at least one non-rechargeable battery, at least one storage battery and/or a connection to an electrical supply network.

4. A lighting system as claimed in claim 1, characterized in that the first connecting member, the second connecting member, the third connecting member and/or the fourth connecting member comprise at least one magnet, which latter comprises in particular at least one permanent magnet and/or at least one electromagnetic means, the attractive magnetic force being able to be generated between the first connecting member and the second connecting member and/or between the third connecting member and the fourth connecting member, by means of the magnet, with, in particular the first connecting member comprising at least one first magnet, the second connecting member comprising at least one second magnet, the third connecting member comprising at least one third magnet and/or the fourth connecting member comprising at least one fourth magnet.

5. A lighting system as claimed in claim 4, characterized in that the first connecting member comprises, at least in a region or regions, at least one first material able to be attracted by a magnetic field generated by the second magnet, the second connecting member comprises, at least in a region or regions, at least one second material able to be attracted by a magnetic field generated by the first magnet, the third connecting member comprises, at least in a region or regions, at least one third material able to be attracted by a magnetic field generated by the fourth magnet, the fourth connecting member comprises, at least in a region or regions, at least one fourth material able to be attracted by a magnetic field generated by the third magnet, and/or the first connecting member comprises the first magnet and the second connecting member comprises the second magnet and/or the third connecting member comprises the third magnet and the fourth connecting member comprises the fourth magnet.

6. A lighting system as claimed in claim 2, characterized in that the first connecting member and/or the third connecting member, on the one hand, comprise or comprises at least one first contact member and the second connecting member and/or the fourth connecting member, on the other hand, comprise or comprises at least one second contact member that is able to be brought into electrical contact with the first contact member, the first contact member and the second contact member preferably being so designed, and in particular being so arranged on a surface of the first connecting member, the second connecting member, the third connecting member and/or the fourth connecting member that an electrical connection can be made between the first connecting member on the one hand and the second connecting member on the other hand and/or between the third connecting member on the one hand and the fourth connecting member on the other hand in at least two, and preferably a plurality of, relative positions between the first connecting member on the one hand and the second connecting member on the other hand and/or between the third connecting member on the one hand and the fourth connecting member on the other hand.

7. A lighting system as claimed in claim 1, characterized in that the first connecting member and/or the third connecting member comprise or comprises at least one first contact surface and the second connecting member and/or the fourth connecting member comprise or comprises a second contact surface complementary to the first contact surface, the attractive magnetic force being able to be generated in particular between the first contact surface and the second contact surface and/or the first contact surface having at least one first point of symmetry, at least one first axis of symmetry and/or at least one first plane of symmetry and/or the second contact surface having at least one second point of symmetry, at least one second axis of symmetry and/or at least one second plane of e symmetry.

8. A lighting system as claimed in claim 7, characterized in that the first contact member, and in particular at least one, and preferably a plurality of, first contact means that the first contact member comprises is/are of a form that is symmetrical, and in particular rotationally symmetrical, mirror-image symmetrical and/or point symmetrical about the first point of symmetry, the first axis of symmetry and/or the first plane of symmetry, and/or the second contact member, and in particular at least one, and preferably a plurality of, second contact means that the second contact member comprises is/are of a form that is symmetrical, and in particular rotationally symmetrical, mirror-image symmetrical and/or point symmetrical about the second point of symmetry, the second axis of symmetry and/or the second plane of symmetry, and/or the first plane of symmetry and the second plane of symmetry, the first axis of symmetry and the second axis of symmetry and/or the first point of symmetry and the second point of symmetry coincide at least when the first connecting member is connected to the second connecting member by means of the attractive magnetic force.

9. A lighting system as claimed in claim 1, characterized in that the base member comprises a plurality of first connecting members that are arranged in particular on different surfaces of the base member, and in particular the base member comprises a first surface adjacent the supporting structure and at least two second surfaces different from the first surface comprise at least one first connecting member, with the first surface and the second surfaces preferably being formed by surfaces of a regular polyhedron, cuboid, cube, pyramid and/or rhombus that is formed in particular by the base member.

10. A lighting system as claimed in claim 1, characterized in that the supporting structure comprises at least one wall of a room, at least one ceiling of a room and/or at least one piece of furniture such as a table and/or chair, and/or the base member comprises at least one wall mounting, at least one lamp foot, at least one free-swinging means and/or at least one supporting member able to be connected to at least one cable system.

11. A lighting system as claimed in claim 1, characterized by at least one control and/or regulating means that the light-emitting member, the first connecting member, the second connecting member and/or the base member comprise or comprises, with at least one operating parameter, and in particular an emission spectrum, at least one brightness of emission and/or at least one period of illumination and/or operation, of the lighting device being able to be controlled and/or regulated by means of the control and/or regulating means, and the lighting device preferably being able to be switched on, switched off and/or dimmed by means thereof.

12. A lighting system as claimed in claim 2, characterized in that the third connecting member comprises at least one power strip and the fourth connecting member comprises at least one plug member able to be plugged onto the power strip and/or the third connecting member comprises at least one female receptacle for at least one male connecting member that the fourth connecting member comprises, and/or the fourth connecting member comprises at least one female receptacle for at least one male connecting member that the third connecting member comprises.

13. A base member characterized in that the base member can be used in a lighting system as claimed in claim 1.

14. A lighting device, characterized in that the lighting device can be used in a lighting system as claimed in claim 1.
